(19) United States
(12) Patent Application Publication
(10) Pub. No.: US 2022/0068275 A1
(43) Pub. Date: Mar. 3, 2022

(54) CONTROL METHOD FOR DISPLAY SYSTEM, DISPLAY SYSTEM, AND CONTROL METHOD FOR DISPLAY APPARATUS

(71) Applicant: SEIKO EPSON CORPORATION, Tokyo (JP)

(72) Inventor: Nona MIMURA, Matsumoto-shi (JP)

(21) Appl. No.: 17/462,480

(22) Filed: Aug. 31, 2021

(30) Foreign Application Priority Data
Aug. 31, 2020 (JP) 2020-145442

(51) Int. Cl. G10L 15/22; G06F 3/16; G10L 15/08

(52) U.S. Cl. CPC G10L 15/22; G06F 3/167; G10L 2015/223; G10L 2015/088; G10L 15/08

(57) ABSTRACT

A control method for a display system having a voice assistant device and a display apparatus comprising: Transmitting, by the display apparatus, state information representing that the display apparatus is in one state of a first state in which a first operation by a voice is allowed and a second state in which the first operation by the voice is not allowed to the voice assistant device; and when the state information is the first state, executing a voice assistant function based on a wake word on the display apparatus and, when the state information is the second state, not executing, by the voice assistant device, the voice assistant function based on the wake word on the display apparatus.

The present application is based on, and claims priority from JP Application Serial Number 2020-145442, filed Aug. 31, 2020, the disclosure of which is hereby incorporated by reference herein in its entirety.

### BACKGROUND

### 1. Technical Field

The present disclosure relates to a control method for a display system, a display system, and a control method for a display apparatus.

### 2. Related Art

In related art, a technique for suppressing false operation of a voice assistant function by another voice than that of a user is known. For example, JP-A-2019-184809 discloses a smart speaker that respectively performs voice recognition on a voice collected by a microphone and a voice output by an external apparatus and, when the respective voices contain wake words, does not activate the voice assistant function.

However, in JP-A-2019-184809, reception of voice data of the voice output by the external apparatus is essential, and the smart speaker may respond to the wake word in a location where the voice data is not receivable and the voice assistant function may falsely operate by another voice than that of a user. Further, in JP-A-2019-184809, it is necessary to constantly analyze the voice data of the voice output by the external apparatus, and the processing load is higher.

### SUMMARY

An aspect of the present disclosure is directed to a control method for a display system having a voice assistant device and a display apparatus configured to communicate with the voice assistant device, the method including transmitting state information representing that the display apparatus is in one state of a first state in which a first operation by a voice is allowed and a second state in which the first operation is not allowed to the voice assistant device by the display apparatus, and, when the state represented by the received state information is the first state, executing a voice assistant function based on a wake word on the display apparatus and, when the state represented by the received state information is the second state, not executing the voice assistant function based on the wake word on the display apparatus by the voice assistant device.

Another aspect of the present disclosure is directed to a display system including a voice assistant device, and a display apparatus configured to communicate with the voice assistant device, wherein the display apparatus is in one state of a first state in which a first operation by a voice is allowed and a second state in which the first operation is not allowed, and transmits state information representing that the display apparatus is in one state of the first state in which the first operation by the voice is allowed and the second state in which the first operation is not allowed to the voice assistant device, and, when the state represented by the received state information is the first state, the voice assistant device executes a voice assistant function based on a wake word on the display apparatus and, when the state represented by the received state information is the second state, does not execute the voice assistant function based on the wake word on the display apparatus.

Yet another aspect of the present disclosure is directed to a control method for a display apparatus having a voice detection unit, configured to execute a voice assistant function based on a wake word, and being in one state of a first state and a second state, the method including, when a state of the display apparatus is the first state in which an operation by a voice detected by the voice detection unit is allowed and the voice detected by the voice detection unit contains the wake word, responding to the wake word and, when the state of the display apparatus is the second state in which the operation by the voice detected by the voice detection unit is not allowed, not responding to the wake word.

### BRIEF DESCRIPTION OF THE DRAWINGS

FIG. 1 shows a configuration of a projector.

FIG. 2 is a flowchart showing an operation of the projector.

FIG. 3 is a flowchart showing an operation of the projector.

FIG. 4 shows a configuration of a display system.

FIG. 5 is a flowchart showing an operation of the display system.

FIG. 6 is a flowchart showing an operation of the display system.

FIG. 7 is a flowchart showing an operation of the projector.

FIG. 8 is a flowchart showing an operation of the projector.

### DESCRIPTION OF EXEMPLARY EMBODIMENTS

### First Embodiment

A first embodiment will be explained.

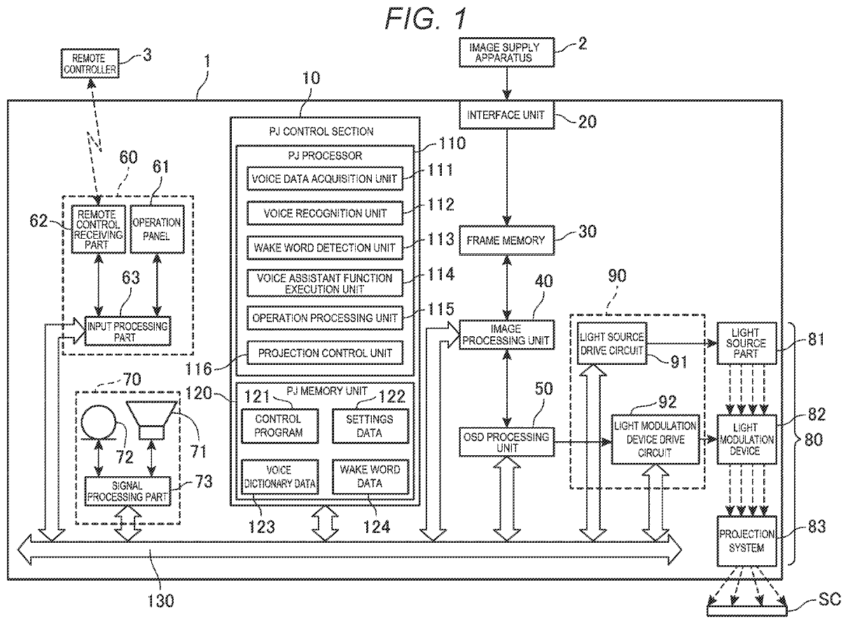

FIG. 1 is a block diagram showing a configuration of a projector 1. The projector 1 corresponds to an example of a display apparatus.

To the projector 1, an image supply apparatus 2 is coupled as an external apparatus. The image supply apparatus 2 outputs image data to the projector 1. The projector 1 projects an image on a screen SC as a projection surface based on the image data input from the image supply apparatus 2. The projection corresponds to an example of display.

The image data input from the image supply apparatus 2 is image data compliant to a predetermined standard. The image data may be still image data or moving image data with or without voice data.

The image supply apparatus 2 is the so-called image source that outputs image data to the projector 1. The specific configuration of the image supply apparatus 2 is not limited, but may be any apparatus that can be coupled to the projector 1 and output image data to the projector 1. For example, as the image supply apparatus 2, a disc-type recording media reproducing apparatus, a television tuner apparatus, a personal computer, a document camera, or the like may be used.

The screen SC may be a screen like a curtain, or a wall surface of a building or a flat surface of an installed object may be used as the screen SC. The screen SC is not limited to a flat surface, but may be a curved surface or an uneven surface.

The projector 1 includes a PJ control section 10.

The PJ control section 10 includes a PJ processor 110 as a processor that executes programs of a CPU, an MPU, etc. and a PJ memory unit 120 and controls the respective parts of the projector 1. The PJ control section 10 executes various kinds of processing by cooperation of hardware and software to control the PJ processor 110 to read a control program 121 stored in the PJ memory unit 120 and execute processing. Further, the PJ control section 10 functions as a voice data acquisition unit 111, a voice recognition unit 112, a wake word detection unit 113, a voice assistant function execution unit 114, an operation processing unit 115, and a projection control unit 116 by controlling the PJ processor 110 to read and execute the control program 121. The details of these functional blocks will be described later.

The PJ memory unit 120 has a memory area for storing programs executed by the PJ processor 110 and data processed by the PJ processor 110. The PJ memory unit 120 has a non-volatile memory area for non-volatile storage of programs and data. Further, the PJ memory unit 120 includes a volatile memory area and may form a work area for temporarily storing programs executed and data processed by the PJ processor 110.

The PJ memory unit 120 stores settings data 122, voice dictionary data 123, and wake word data 124 in addition to the control program 121 executed by the PJ processor 110.

The settings data 122 contains setting values on the operation of the projector 1. The setting values contained in the settings data 122 include e.g. setting values indicating volume levels of voices output by a speaker 71, setting values indicating details of processing executed by an image processing unit 40 and an OSD processing unit 50, parameters used for processing by the image processing unit 40 and the OSD processing unit 50.

The voice dictionary data 123 is data for the voice recognition unit 112 to recognize a voice of a user detected by a microphone 72. For example, the voice dictionary data 123 contains dictionary data for converting digital data of the voice of the user into texts in Japanese, English, or another set language.

The wake word data 124 is data representing wake words as predetermined words. Note that the wake words may be words containing an arbitrary word.

The projector 1 includes an interface unit 20, a frame memory 30, the image processing unit 40, the OSD processing unit 50, an operation unit 60, and a voice processing unit 70. These respective units are coupled to the PJ control section 10 to communicate data via a bus 130.

The interface unit 20 includes communication hardware such as a connector and an interface circuit compliant to a predetermined communication standard. In FIG. 1, the connector and the interface circuit are not shown. The interface unit 20 transmits and receives image data, control data, etc. between the image supply apparatus 2 and itself according to control by the PJ control section 10 and according to the predetermined communication standard. As an interface of the interface unit 20, an interface that can digitally transmit pictures and voices e.g. HDMI (High-Definition Multimedia Interface), DisplayPort, HDBaseT, USB Type-C, and 3G-SDI (Serial Digital Interface) may be used. The HDMI is a registered trademark. The HDBaseT is a registered trademark. Alternatively, as the interface, an interface for data communication such as Ethernet, IEEE1394, or USB may be used. The Ethernet is a registered trademark. Alternatively, as the interface, an interface including an analog terminal such as an RCA terminal, a VGA terminal, an S terminal, or a D terminal that can transmit and receive analog picture signals may be used.

The frame memory 30, the image processing unit 40, and the OSD processing unit 50 are formed using e.g. integrated circuits. The integrated circuits include an LSI, an ASIC (Application Specific integrated Circuit), a PLD (Programmable Logic Device), an FPGA (Field-Programmable Gate Array), and an SoC (System-on-a-chip). Further, a part of the configuration of the integrated circuit may contain an analog circuit or the PJ control section 10 and the integrated circuit may be combined.

The frame memory 30 includes a plurality of banks. Each bank has memory capacity in which one frame of image data can be written. The frame memory 30 includes e.g. an SDRAM. Note that SDRAM is an abbreviation for Synchronous Dynamic Random Access Memory.

The image processing unit 40 performs image processing e.g. resolution conversion processing or resizing processing, distortion correction, shape correction processing, digital zooming processing, and adjustment of tint and brightness of images on the image data expanded on the frame memory 30. The image processing unit 40 executes processing designated by the PJ control section 10 and performs processing using parameters input from the PJ control section 10 as necessary. Further, the image processing unit 40 can execute a combination of a plurality kinds of the above described image processing.

The image processing unit 40 reads and outputs the processed image data from the frame memory 30 to the OSD processing unit 50.

The OSD processing unit 50 performs processing for superimposing a user interface relating to the settings of the projector 1 on the image represented by the image data input from the image processing unit 40 according to the control by the PJ control section 10. In the following description, the user interface will be referred to as “settings UI”.

When the PJ control section 10 instructs superimposition of the settings UI, the OSD processing unit 50 synthesizes image data of the settings UI on the image data input from the image processing unit 40 so that the settings UI may be superimposed in a predetermined position on the image represented by the image data input from the image processing unit 40. The synthesized image data is output to a light modulation device drive circuit 92. Note that, when an instruction to superimpose the settings UI is not given from the PJ control section 10, the OSD processing unit 50 outputs the unprocessed image data input from the image processing unit 40 as it is to the light modulation device drive circuit 92.

The operation unit 60 includes an operation panel 61, a remote control receiving part 62, and an input processing part 63.

The operation panel 61 is provided in a housing of the projector 1 and includes various switches that can be operated by the user. The input processing part 63 detects operation of the respective switches of the operation panel 61.

The remote control receiving part 62 receives an infrared signal transmitted by a remote controller 3. The input processing part 63 decodes the signal received by the remote control receiving part 62 and generates and outputs operation data to the PJ control section 10.

The input processing part 63 is coupled to the operation panel 61 and the remote control receiving part 62. When the operation by the user is received by the operation panel 61 or the remote control receiving part 62, the input processing part 63 generates and outputs operation data corresponding to the received operation to the PJ control section 10.

The voice processing unit 70 includes the speaker 71, the microphone 72, and a signal processing part 73. The microphone 72 corresponds to an example of a voice detection unit.

When the digital voice data is input from the PJ control section 10, the signal processing part 73 converts the input voice data from digital into analog. The signal processing part 73 outputs the converted analog voice data to the speaker 71. The speaker 71 outputs a voice based on the input voice data.

Further, when the microphone 72 detects a voice, analog voice data representing the voice detected by the microphone 72 is input from the microphone 72 to the signal processing part 73. The signal processing part 73 converts the voice data input from the microphone 72 from analog to digital and outputs the converted digital voice data to the PJ control section 10.

The projector 1 includes a projection unit 80 and a drive unit 90 that drives the projection unit 80.

The projection unit 80 includes a light source part 81, a light modulation device 82, and a projection system 83. The drive unit 90 includes a light source drive circuit 91 and the light modulation device drive circuit 92.

The light source drive circuit 91 is coupled to the PJ control section 10 via the bus 130 and coupled to the light source part 81. The light source drive circuit 91 turns on or off the light source part 81 according to the control by the PJ control section 10.

The light modulation device drive circuit 92 is coupled to the PJ control section 10 via the bus 130 and coupled to the light modulation device 82. The light modulation device drive circuit 92 drives the light modulation device 82 and draws images in units of frames on light modulation elements provided in the light modulation device 82 according to the control by the PJ control section 10. Image data corresponding to respective primary colors of R, G, B is input from the image processing unit 40 to the light modulation device drive circuit 92. The light modulation device drive circuit 92 converts the input image data into data signals suitable for operation of liquid crystal panels as the light modulation elements of the light modulation device 82. The light modulation device drive circuit 92 applies voltages to respective pixels of the respective liquid crystal panels based on the converted data signals and draws images on the respective liquid crystal panels.

The light source part 81 includes a lamp such as a halogen lamp, a xenon lamp, or a super high-pressure mercury lamp or a solid-state light source such as an LED or a laser beam source. The light source part 81 is turned on by electric power supplied from the light source drive circuit 91 and emits light toward the light modulation device 82.

The light modulation device 82 includes e.g. three liquid crystal panels corresponding to the three primary colors of R, G, and B. R refers to red, G refers to green, and B refers to blue. The light output from the light source part 81 is separated into color lights of the three colors RGB and respectively entered into the corresponding liquid crystal panels. The respective three liquid crystal panels are transmissive liquid crystal panels and modulate transmitted lights and generate image lights. The image lights passing through the respective liquid crystal panels and modulated are combined by a combining system such as a cross dichroic prism and output to the projection system 83.

In the embodiment, a case where the light modulation device 82 includes the transmissive liquid crystal panels as the light modulation elements is exemplified, however, the light modulation elements may be reflective liquid crystal panels or digital mirror devices.

The projection system 83 includes a lens, a mirror, etc. for focusing the image light modulated by the light modulation device 82 on the screen SC. The projection system 83 may include a zoom mechanism to enlarge or reduce the image projected on the screen SC and a focus adjustment mechanism to adjust focus.

Next, the functional blocks of the PJ control section 10 will be explained.

The voice data acquisition unit 111 acquires voice data representing the voice detected by the microphone 72 from the voice processing unit 70. The voice data acquisition unit 111 outputs the acquired voice data to the voice recognition unit 112 in cases to be described later.

The voice recognition unit 112 recognizes the voice detected by the microphone 72 based on the voice data acquired by the voice data acquisition unit 111. The voice recognition unit 112 outputs a result of the voice recognition to the wake word detection unit 113 and the voice assistant function execution unit 114. For example, the voice recognition unit 112 performs processing of analyzing the voice data of the voice collected by the microphone 72 and converting the voice detected by the microphone 72 into text with reference to the voice dictionary data 123 stored by the PJ memory unit 120. Then, the voice recognition unit 112 outputs the voice data converted into text to the wake word detection unit 113 and the voice assistant function execution unit 114 as the result of the voice recognition.

The wake word detection unit 113 determines whether or not the result of the voice recognition output by the voice recognition unit 112 contains a wake word. More specifically, the wake word detection unit 113 determines whether or not the result of the voice recognition contains a word coincident with the wake word represented by the wake word data 124. For example, the wake word detection unit 113 determines whether or not the wake word represented by the wake word data 124 is contained by performing a string search on the text voice data. The wake word detection unit 113 outputs wake word detection information representing whether or not the wake word is contained as a determination result to the voice assistant function execution unit 114.

The voice assistant function execution unit 114 executes a voice assistant function. The voice assistant function is a function of performing processing corresponding to a voice subsequent to the wake word. The voice assistant function includes e.g. turning on and off of power of the projector 1, start of image projection, switching between image sources, projection of the settings UI, and information search and information output of pictures, music, etc. When the wake word detection information output by the wake word detection unit 113 represents that the wake word is contained, the voice assistant function execution unit 114 executes processing corresponding to the voice subsequent to the wake word. Note that, when the voice assistant function executed by the voice assistant function execution unit 114 includes information search and information output using a network NW, the projector 1 includes a communication unit that can communicate with an apparatus coupled to the network NW as a functional unit.

For example, it is assumed that the voice recognition unit 112 recognizes a voice “my projector, start projection” and “my projector” is a wake word. In this example, the voice assistant function execution unit 114 requests the projection control unit 116 to start image projection according to the voice “start projection” and starts image projection.

Or, for example, it is assumed that the voice recognition unit 112 recognizes a voice “my projector, power on” and “my projector” is a wake word. In this example, the voice assistant function execution unit 114 turns on power of the projector 1 according to the voice “power on”.

Or, for example, it is assumed that the voice recognition unit 112 recognizes a voice “my projector, display settings window” and “my projector” is a wake word. In this example, the voice assistant function execution unit 114 requests the projection control unit 116 to start projection of the settings UI according to the voice “display settings window” and starts projection of the settings UI.

The operation processing unit 115 executes processing corresponding to a non-voice operation received by the operation unit 60. The non-voice operation is an operation by another than the voice e.g. an operation on various switches provided on the housing of the projector 1 and an operation on various switches provided on the remote controller 3. The non-voice operation corresponds to an example of a second operation. Hereinafter, the operation by voice is referred to as “voice operation”. The voice operation corresponds to an example of a first operation.

For example, when the operation data output from the operation unit 60 is operation data for increasing the volume, the operation processing unit 115 sets the volume level of the voice output by the speaker 71 to be higher than the current volume level by updating the setting value of the volume level in the settings data 122.

The projection control unit 116 projects the image on the screen SC by controlling the image processing unit 40, the OSD processing unit 50, the drive unit 90, etc.

Specifically, the projection control unit 116 controls the image processing unit 40 to process the image data expanded in the frame memory 30 by the image processing unit 40. In this regard, the projection control unit 116 reads the parameters necessary for the image processing unit 40 to process from the PJ memory unit 120 and outputs the parameters to the image processing unit 40.

The projection control unit 116 controls the OSD processing unit 50 to process the image data input from the image processing unit 40 by the OSD processing unit 50.

The projection control unit 116 controls the light source drive circuit 91 and the light modulation device drive circuit 92 to turn on the light source part 81 by the light source drive circuit 91 and drive the light modulation device 82 by the light modulation device drive circuit 92, and displays the image on the screen SC by projecting the image light using the projection unit 80. Further, the projection control unit 116 controls the projection system 83 to activate the motor and adjusts zoom and focus of the projection system 83.

The projector 1 of the embodiment is in one state of a first state and a second state.

The first state is a state in which the voice operation and the non-voice operation by the user are allowed. That is, the first state is a state in which processing corresponding to the voice operation and the non-voice operation received from the user can be executed. Specifically, the first state is a state in which no voice is output, e.g. a state in which only the settings UI is projected, a state in which no image is projected, a state in which a picture with no voice is projected, a state in which no image data is supplied from the image supply apparatus 2, a state in which the volume of the speaker 71 is set to zero, a state in which picture projection is paused, or the like.

The second state is a state in which the voice operation by the user is not allowed, but the non-voice operation by the user is allowed. That is, the second state is a state in which processing corresponding to the voice operation by the user is not executed, but processing corresponding to the non-voice operation by the user can be executed. Specifically, the second state is a state in which a voice is output, e.g. a state in which a picture with a voice is projected or a state in which an image is projected at the volume of the speaker 71 not zero.

Note that, in the second state, a voice operation with a non-voice operation is allowed. Specifically, in the second state, when a switch for forcibly enabling a voice operation is operated, the voice operation is allowed.

In the above described configuration, the projector 1 in the embodiment executes the following operation.

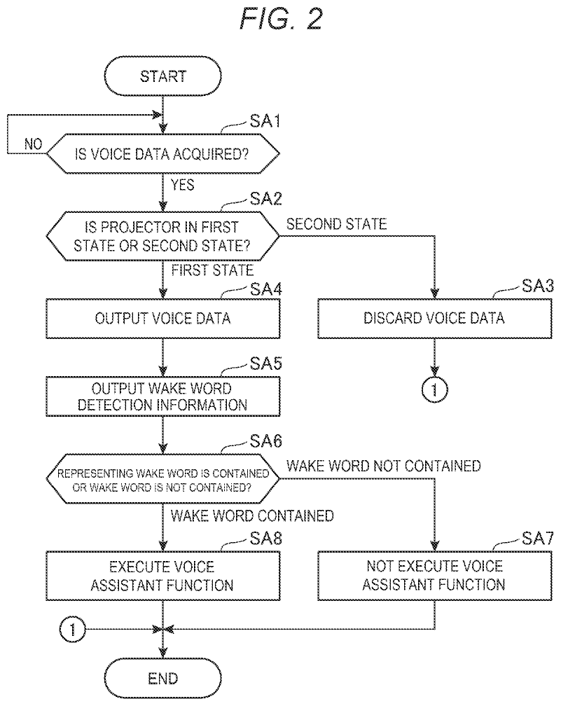

FIG. 2 is a flowchart showing an operation of the projector 1.

The voice data acquisition unit 111 of the PJ control section 10 of the projector 1 determines whether or not voice data of the voice detected by the microphone 72 is acquired from the voice processing unit 70 (step SA1).

When determining that the voice data is not acquired from the voice processing unit 70 (step SA1: NO), the voice data acquisition unit 111 executes the processing at step SA1 again.

On the other hand, when determining that the voice data is acquired from the voice processing unit 70 (step SA1: YES), the voice data acquisition unit 111 determines whether the state of the projector 1 is the first state or the second state (step SA2).

When determining that the state of the projector 1 is the second state (step SA2: “SECOND STATE”), the voice data acquisition unit 111 discards the voice data acquired from the voice processing unit 70 (step SA3) and ends the processing.

On the other hand, when determining that the state of the projector 1 is the first state (step SA2: “FIRST STATE”), the voice data acquisition unit 111 outputs the acquired voice data to the wake word detection unit 113 and the voice assistant function execution unit 114 (step SA4).

The wake word detection unit 113 determines whether or not the voice represented by the voice data output by the voice data acquisition unit 111 contains the wake word, and outputs the wake word detection information to the voice assistant function execution unit 114 (step SA5).

Then, the voice assistant function execution unit 114 determines whether the wake word detection information represents that the wake word is contained or represents that the wake word is not contained (step SA6).

When determining that the wake word detection information represents that the wake word is not contained (step SA6: “WAKE WORD NOT CONTAINED”), the voice assistant function execution unit 114 does not execute the voice assistant function (step SA7).

On the other hand, when determining that the wake word detection information represents that the wake word is contained (step SA6: “WAKE WORD CONTAINED”), the voice assistant function execution unit 114 executes the voice assistant function based on the voice detected by the microphone 72 subsequent to the wake word (step SA8).

### Modified Example

Next, a modified example of the embodiment will be explained.

The modified example is different from the above described embodiment in the operation of the projector 1.

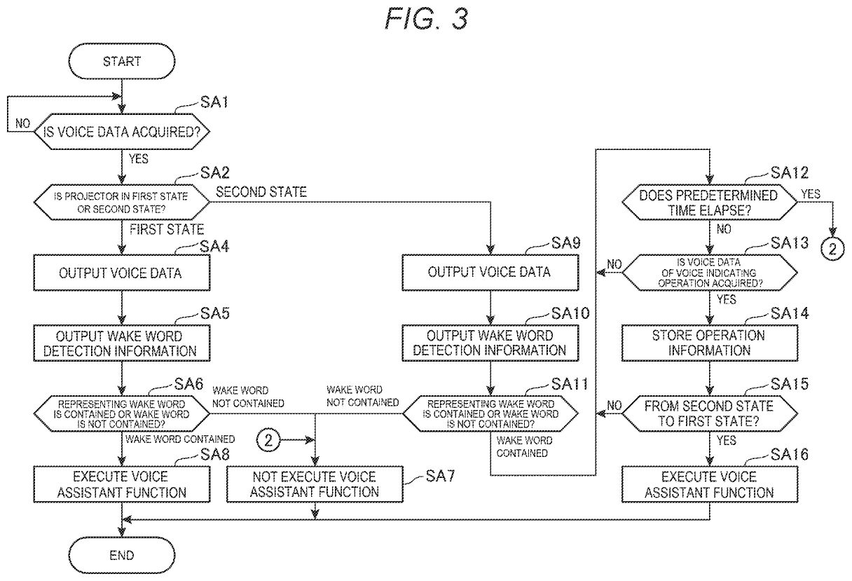

FIG. 3 is a flowchart showing an operation of the projector 1 in the modified example.

In FIG. 3, the same steps as those in the flowchart shown in FIG. 2 have the same step numbers and the detailed explanation will be omitted.

When determining that the state of the projector 1 is the second state (step SA2: “SECOND STATE”), the voice data acquisition unit 111 of the PJ control section 10 of the projector 1 outputs the voice data acquired from the voice processing unit 70 to the wake word detection unit 113 and the voice assistant function execution unit 114 (step SA9).

The wake word detection unit 113 determines whether or not the voice represented by the voice data output by the voice data acquisition unit 111 contains the wake word, and outputs the wake word detection information to the voice assistant function execution unit 114 (step SA10).

Then, the voice assistant function execution unit 114 determines whether the wake word detection information represents that the wake word is contained or represents that the wake word is not contained (step SA11).

When determining that the wake word detection information represents that the wake word is not contained (step SA11: “WAKE WORD NOT CONTAINED”), the voice assistant function execution unit 114 does not execute the voice assistant function (step SA7).

On the other hand, when determining that the wake word detection information represents that the wake word is contained (step SA11: “WAKE WORD CONTAINED”), the voice assistant function execution unit 114 determines whether or not a predetermined time elapses after the detection of the wake word (step SA12).

When determining that the predetermined time elapses after the detection of the wake word (step SA12: YES), the voice assistant function execution unit 114 does not execute the voice assistant function (step SA7).

On the other hand, when determining that the predetermined time does not elapse after the detection of the wake word (step SA12: NO), the voice assistant function execution unit 114 determines whether or not the voice data acquisition unit 111 acquires the voice data of the voice indicating the operation (step SA13). That is, at step SA13, the voice assistant function execution unit 114 determines whether or not the projector 1 receives the voice operation.

When determining that the voice data acquisition unit 111 does not acquire the voice data of the voice indicating the operation (step SA13: NO), the voice assistant function execution unit 114 executes the processing at step SA12 again.

On the other hand, when determining that the voice data acquisition unit 111 acquires the voice data of the voice indicating the operation (step SA13: YES), the voice assistant function execution unit 114 stores operation information representing the voice operation corresponding to the voice data acquired by the voice data acquisition unit 111 in the PJ memory unit 120 (step SA14).

Then, the voice assistant function execution unit 114 determines whether or not the state of the projector 1 changes from the second state to the first state (step SA15).

When determining that the state of the projector 1 does not change from the second state to the first state, that is, the state of the projector 1 remains the second state (step SA15: NO), the voice assistant function execution unit 114 executes the processing at step SA12 again.

On the other hand, when determining that the state of the projector 1 changes to the first state (step SA15: YES), the voice assistant function execution unit 114 executes the processing corresponding to the voice operation represented by the operation information stored in the PJ memory unit 120 as the voice assistant function (step SA16). Note that the operation information is deleted from the PJ memory unit 120 when the voice assistant function execution unit 114 executes the voice assistant function.

As described above, in the control method for the projector 1, the projector 1 is in one state of the first state in which the operation by the voice detected by the microphone 72 is allowed and the second state in which the operation by the voice detected by the microphone 72 is not allowed. When the state of the projector 1 is the first state and the voice detected by the microphone 72 contains the wake word, the control method for the projector 1 responds to the wake word and, when the state of the projector 1 is the second state, does not respond to the wake word.

According to the configuration, in the state in which the voice operation is allowed, the projector 1 responds to the wake word and, in the state in which the voice operation is not allowed, the projector 1 does not respond to the wake word, and thereby, false operation of the voice assistant function by another voice than that of the user may be suppressed independent of the placement location of the projector 1. Further, whether or not to respond to the wake word is changed according to the state of the projector 1 and it is not necessary to continuously analyze the voice data detected by the microphone 72, and thus, the processing load may be suppressed. Therefore, the projector 1 may suppress the false operation of the voice assistant function according to the wake word by another voice than that of the user with the suppressed processing load.

### Second Embodiment

Next, a second embodiment will be explained.

In the second embodiment, the same component elements as the component elements of the first embodiment have the same signs and the detailed explanation will be omitted.

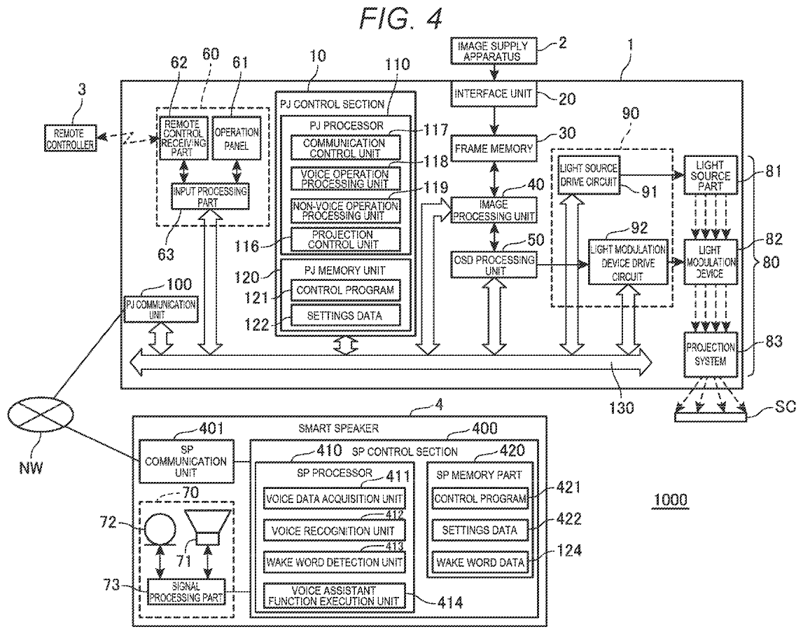

FIG. 4 shows a configuration of a display system 1000 of the second embodiment.

The display system 1000 includes a smart speaker 4 and the projector 1. The smart speaker 4 corresponds to an example of a voice assistant device. In the display system 1000, the smart speaker 4 and the projector 1 can communicate via the network NW. The network NW includes the Internet, a telephone network, and another communication network.

The smart speaker 4 is a device that executes the voice assistant function, and detects a voice using the internal microphone 72 and executes the voice assistant function of control of the projector 1 and the other apparatuses coupled to the network NW, information search using the network NW, output of search results, etc. based on the detected voice.

The smart speaker 4 includes an SP control section 400, an SP communication unit 401, and the voice processing unit 70.

The SP control section 400 includes an SP processor 410 as a processor that executes programs of a CPU, an MPU, etc. and an SP memory part 420, and controls the respective parts of the smart speaker 4. The SP control section 400 executes various kinds of processing in cooperation with hardware and software to control the SP processor 410 to read a control program 421 stored in the SP memory part 420 and execute processing. Further, the SP control section 400 functions as a voice data acquisition unit 411, a voice recognition unit 412, a wake word detection unit 413, and a voice assistant function execution unit 414 by controlling the SP processor 410 to read and execute the control program 421.

The SP memory part 420 has a memory area for storing programs executed by the SP processor 410 and data processed by the SP processor 410. The SP memory part 420 has a non-volatile memory area for non-volatile storage of programs and data. Further, the SP memory part 420 includes a volatile memory area and may form a work area for temporarily storing programs executed and data processed by the SP processor 410.

The SP memory part 420 stores settings data 422 containing setting values on the operation of the smart speaker 4 and the wake word data 124 in addition to the control program 421 executed by the SP processor 410.

The SP communication unit 401 includes communication hardware compliant to a predetermined communication standard, and communicates with an apparatus coupled to the network NW according to the predetermined communication standard under control of the SP control section 400. The SP communication unit 401 of the embodiment can communicate with the projector 1 via the network NW. The communication standard used by the SP communication unit 401 may be a wireless communication standard or a wired communication standard.

The voice processing unit 70 of the smart speaker 4 is formed to be the same as the voice processing unit 70 of the projector 1 of the first embodiment. When digital voice data is input from the SP control section 400, the signal processing part 73 of the voice processing unit 70 of the smart speaker 4 converts the input voice data from digital into analog and outputs the converted analog voice data to the speaker 71. The speaker 71 outputs a voice based on the input voice data. Further, when the microphone 72 collects a voice, analog voice data representing the voice collected by the microphone 72 is input from the microphone 72 to the signal processing part 73. The signal processing part 73 converts the voice data input from the microphone 72 from analog to digital and outputs the converted digital voice data to the SP control section 400.

As described above, the SP control section 400 functions as the voice data acquisition unit 411, the voice recognition unit 412, the wake word detection unit 413, and the voice assistant function execution unit 414.

The voice data acquisition unit 411 acquires voice data representing the voice detected by the microphone 72 from the voice processing unit 70. The voice data acquisition unit 411 outputs the voice data acquired from the voice processing unit 70 to the voice recognition unit 412.

Like the voice recognition unit 112 of the first embodiment, the voice recognition unit 412 recognizes the voice detected by the microphone 72. The voice recognition unit 412 of the embodiment transmits the voice data to a server, an AI (Artificial Intelligence), or the like coupled to the network NW and obtains a result of voice recognition from the server, AI, or the like, and thereby, recognizes the voice detected by the microphone 72. The voice recognition unit 412 outputs the result of voice recognition to the wake word detection unit 413 and the voice assistant function execution unit 414.

Like the wake word detection unit 113 of the first embodiment, the wake word detection unit 413 determines whether or not the voice recognized by the voice recognition unit 412 contains the wake word, and outputs the wake word detection information to the voice assistant function execution unit 414.

Like the voice assistant function execution unit 114 of the first embodiment, when the wake word detection information represents that the wake word is contained, the voice assistant function execution unit 414 executes processing corresponding to the voice subsequent to the wake word as the voice assistant function. The voice assistant function execution unit 414 of the embodiment executes processing e.g. start of image projection, switching between image sources, start of projection of the settings UI, or the like as the voice assistant function. When executing the voice assistant function on the projector 1, the voice assistant function execution unit 414 transmits a control command to control the projector 1.

For example, it is assumed that the voice recognition unit 412 recognizes a voice “my projector, start projection” and “my projector” is a wake word. In this example, the voice assistant function execution unit 414 transmits a control command to control the projector 1 to start image projection according to the voice “start projection” to the projector 1 via the network NW.

Next, the configuration of the projector 1 will be explained.

Like the first embodiment, in this embodiment, the projector 1 is in one state of the first state and the second state.

The projector 1 of the embodiment includes a PJ communication unit 100 compared to the projector 1 of the first embodiment. Further, in the projector 1 of the embodiment, compared to the projector 1 of the first embodiment, the PJ control section 10 functions as a communication control unit 117, a voice operation processing unit 118, a non-voice operation processing unit 119, and the projection control unit 116.

Note that, as the projector 1 in FIG. 4, the configuration without the voice processing unit 70 is exemplified, however, the projector 1 of the embodiment may include the voice processing unit 70 or the other component elements than the microphone 72 in the voice processing unit 70 like the first embodiment.

The PJ communication unit 100 includes communication hardware compliant to a predetermined communication standard, and communicates with an apparatus coupled to the network NW according to the predetermined communication standard under control of the PJ communication unit 100. The PJ communication unit 100 of the embodiment can communicate with the smart speaker 4 via the network NW. The communication standard used by the PJ communication unit 100 may be a wireless communication standard or a wired communication standard.

The communication control unit 117 transmits and receives information to and from the smart speaker 4 using the PJ communication unit 100. The communication control unit 117 receives the control command transmitted by the voice assistant function execution unit 414 of the smart speaker 4 using the PJ communication unit 100. The communication control unit 117 outputs the received control command to the voice operation processing unit 118. Further, when receiving state request information for requesting the state of the projector 1 from the smart speaker 4, the communication control unit 117 transmits state information representing one of the first state and the second state to the smart speaker 4.

The voice operation processing unit 118 executes processing based on the control command output by the communication control unit 117. For example, when the control command is a control command to start image projection, the voice operation processing unit 118 requests the projection control unit 116 to start image projection and starts image projection. In this manner, the voice operation processing unit 118 executes processing corresponding to the voice operation received by the smart speaker 4 by executing the processing according to the control command.

The non-voice operation processing unit 119 executes the same processing as that of the operation processing unit 115 of the first embodiment.

In the above described configuration, the display system 1000 in the embodiment executes the following operation. In the following explanation of the operation, the voice received by the smart speaker 4 indicates the operation for the projector 1.

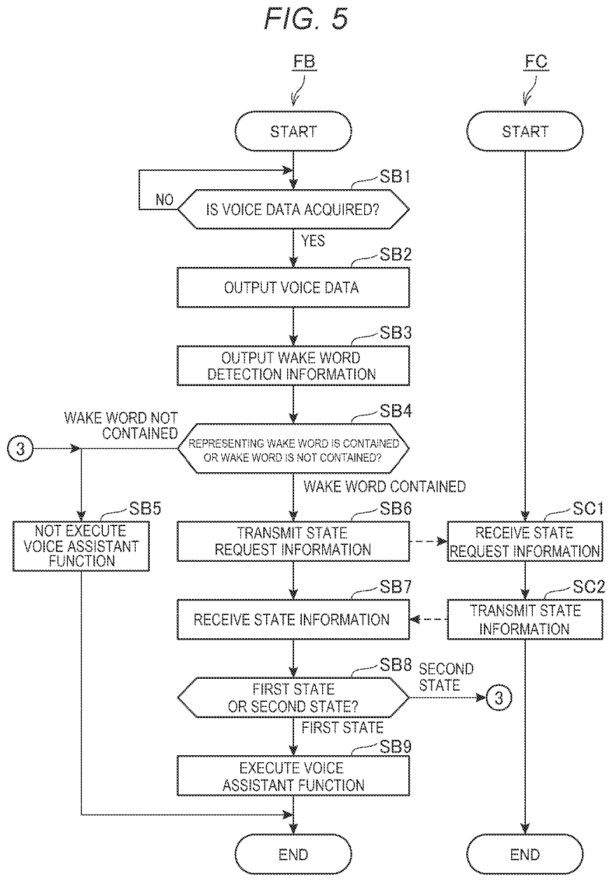

FIG. 5 is a flowchart showing an operation of the projector 1. In FIG. 5, a flowchart FB shows the operation of the smart speaker 4 and a flowchart FC shows the operation of the projector 1.

The voice data acquisition unit 411 of the SP control section 400 of the smart speaker 4 determines whether or not voice data of the voice detected by the microphone 72 is acquired from the voice processing unit 70 (step SB1).

When determining that the voice data is not acquired from the voice processing unit 70 (step SB1: NO), the voice data acquisition unit 411 executes the processing at step SB1 again.

On the other hand, when determining that the voice data is acquired from the voice processing unit 70 (step SB1: YES), the voice data acquisition unit 411 outputs the acquired voice data to the wake word detection unit 413 and the voice assistant function execution unit 414 (step SB2).

Then, the wake word detection unit 413 determines whether or not the voice represented by the voice data output by the voice data acquisition unit 411 contains the wake word, and outputs the wake word detection information to the voice assistant function execution unit 414 (step SB3).

Then, the voice assistant function execution unit 414 determines whether the wake word detection information represents that the wake word is contained or represents that the wake word is not contained (step SB4).

When determining that the wake word detection information represents that the wake word is not contained (step SB4: “WAKE WORD NOT CONTAINED”), the voice assistant function execution unit 414 does not execute the voice assistant function (step SB5).

On the other hand, when determining that the wake word detection information represents that the wake word is contained (step SB4: “WAKE WORD CONTAINED”), the voice assistant function execution unit 414 transmits the state request information for requesting the state of the projector 1 to the projector 1 using the SP communication unit 401 (step SB6).

Referring to the flowchart FC, when receiving the state request information by the PJ communication unit 100 (step SC1), the communication control unit 117 of the PJ control section 10 of the projector 1 transmits the state information representing the state of the projector 1 (step SC2). The state of the projector 1 represented by the state information is one of the first state and the second state.

Referring to the flowchart FB, when receiving the state information from the projector 1 by the SP communication unit 401 (step SB7), the voice assistant function execution unit 414 of the smart speaker 4 determines whether the state of the projector 1 represented by the received state information is the first state or the second state (step SB8).

When determining that the state of the projector 1 is the second state (step SB8: “SECOND STATE”), the voice assistant function execution unit 414 does not execute the voice assistant function on the projector 1 (step SB5).

On the other hand, when determining that the state of the projector 1 is the first state (step SB8: “FIRST STATE”), the voice assistant function execution unit 414 executes the voice assistant function on the projector 1 based on the voice subsequent to the wake word (step SB9).

### Modified Example

Next, a modified example of the operation of the display system 1000 shown in FIG. 5 will be explained.

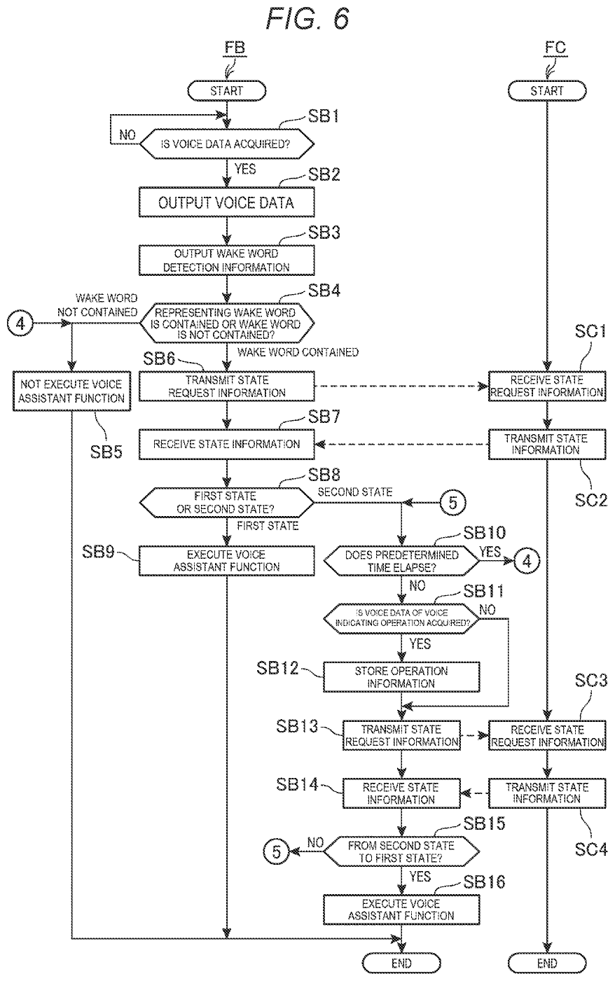

FIG. 6 is a flowchart showing the modified example of the operation of the display system 1000.

In FIG. 6, the same steps as those in the flowchart shown in FIG. 5 have the same step numbers and the detailed explanation will be omitted.

When determining that the state of the projector 1 is the second state (step SB8: “SECOND STATE”), the voice assistant function execution unit 414 determines whether or not a predetermined time elapses after the detection of the wake word (step SB10).

When determining that the predetermined time elapses after the detection of the wake word (step SB10: YES), the voice assistant function execution unit 414 does not execute the voice assistant function (step SB5).

On the other hand, when determining that the predetermined time does not elapse after the detection of the wake word (step SB10: NO), the voice assistant function execution unit 414 determines whether or not the voice data acquisition unit 411 acquires the voice data of the voice indicating the operation (step SB11). That is, at step SB11, the voice assistant function execution unit 414 determines whether or not the smart speaker 4 receives the voice operation.

When determining that the voice data acquisition unit 411 does not acquire the voice data of the voice indicating the operation (step SB11: NO), the voice assistant function execution unit 414 moves the processing to step SB13.

On the other hand, when determining that the voice data acquisition unit 411 acquires the voice data of the voice indicating the operation (step SB11: YES), the voice assistant function execution unit 414 stores the operation information representing the voice operation corresponding to the voice data acquired by the voice data acquisition unit 411 in the SP memory part 420 (step SB12).

Then, the voice assistant function execution unit 414 transmits the state request information to the projector 1 by the SP communication unit 401 (step SB13).

Referring to the flowchart FC, when receiving the state request information by the PJ communication unit 100 (step SC3), the communication control unit 117 of the PJ control section 10 of the projector 1 transmits the state information representing that the state of the projector 1 is one of the first state and the second state (step SC4).

Referring to the flowchart FB, when receiving the state information from the projector 1 by the SP communication unit 401 (step SB14), the voice assistant function execution unit 414 of the smart speaker 4 determines whether or not the state of the projector 1 changes from the second state to the first state based on the received state information (step SB15).

When determining that the state of the projector 1 does not change from the second state to the first state, that is, the state of the projector 1 remains the second state (step SB15: NO), the voice assistant function execution unit 414 executes the processing at step SB10 again.

On the other hand, when determining that the state of the projector 1 changes to the first state (step SB15: YES), the voice assistant function execution unit 414 controls the projector 1 to execute the processing corresponding to the voice operation represented by the operation information stored in the SP memory part 420 as the voice assistant function (step SB16). That is, the voice assistant function execution unit 414 transmits the control command to execute the processing for the voice operation represented by the operation information to the projector 1. Note that the operation information is deleted from the SP memory part 420 when the voice assistant function execution unit 414 executes the voice assistant function.

The above described FIGS. 5 and 6 show the operation of the configuration that determines whether or not to execute the voice assistant function according to the state of the projector 1 mainly by the smart speaker 4.

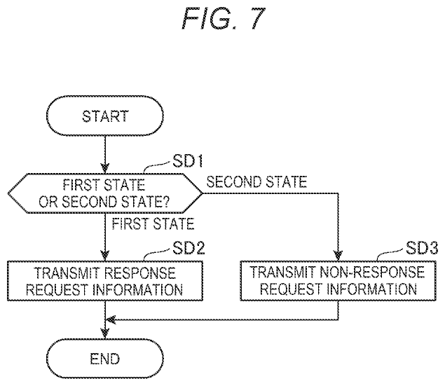

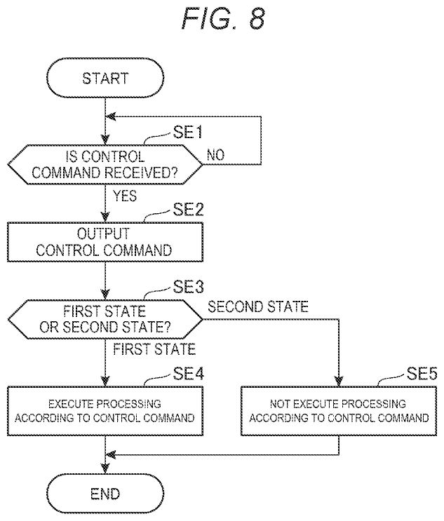

Next, referring to FIGS. 7 and 8, an operation of the configuration that determines whether or not to execute the voice assistant function according to the state of the projector 1 mainly by the projector 1 will be explained.

FIG. 7 is a flowchart showing the operation of the projector 1.

The communication control unit 117 of the projector 1 determines whether the state of the projector 1 is the first state or the second state (step SD1).

When determining that the state of the projector 1 is the second state (step SD1: “SECOND STATE”), the communication control unit 117 transmits non-response request information for requesting not to respond to the wake word to the smart speaker 4 by the PJ communication unit 100 (step SD3).

When receiving the non-response request information from the projector 1, the smart speaker 4 does not respond to the wake word. That is, the voice assistant function execution unit 414 of the smart speaker 4 does not execute the voice assistant function based on the wake word.

Returning to the explanation of step SD1, when determining that the state of the projector 1 is the first state (step SD1: “FIRST STATE”), the communication control unit 117 transmits response request information for requesting to respond to the wake word to the smart speaker 4 by the PJ communication unit 100 (step SD2).

When receiving the response request information from the projector 1, the smart speaker 4 responds to the wake word. That is, the voice assistant function execution unit 414 of the smart speaker 4 is enabled to execute the voice assistant function based on the wake word.

FIG. 8 is a flowchart showing an operation of the projector 1. In the explanation of FIG. 8, it is assumed that, when receiving the voice operation on the projector 1, the smart speaker 4 transmits the control command to execute the processing corresponding to the received voice operation to the projector 1 without the state determination of the projector 1.

The communication control unit 117 of the projector 1 determines whether or not the control command is received from the smart speaker 4 (step SE1).

When determining that the control command is not received from the smart speaker 4 (step SE1: NO), the communication control unit 117 executes the processing at step SE1 again.

When determining that the control command is received from the smart speaker 4 (step SE1: YES), the communication control unit 117 outputs the received control command to the voice operation processing unit 118 (step SE2).

The voice operation processing unit 118 determines whether the state of the projector 1 is the first state or the second state (step SE3).

When determining that the state of the projector 1 is the first state (step SE3: “FIRST STATE”), the voice operation processing unit 118 executes the processing based on the control command output by the communication control unit 117 (step SE4). Thereby, in the display system 1000, the voice assistant function based on the wake word is executed.

On the other hand, when determining that the state of the projector 1 is the second state (step SE3: “SECOND STATE”), the voice operation processing unit 118 does not execute the processing based on the control command output by the communication control unit 117 (step SE5). Thereby, in the display system 1000, the voice assistant function based on the wake word is not executed.

As described above, in the control method for the display system 1000, the projector 1 is in one state of the first state in which the voice operation is allowed and the second state in which the voice operation is not allowed, and transmits the state information representing the state of the projector 1 to the smart speaker 4. In the control method for the display system 1000, when the state represented by the received state information is the first state, the smart speaker 4 executes the voice assistant function based on the wake word on the projector 1 and, when the state represented by the received state information is the second state, does not execute the voice assistant function based on the wake word on the projector 1.

The display system 1000 has the smart speaker 4 and the projector 1 that can communicate with the smart speaker 4. The projector 1 is in one state of the first state in which the voice operation is allowed and the second state in which the voice operation is not allowed, and transmits the state information representing the state of the projector 1 to the smart speaker 4. When the state represented by the received state information is the first state, the smart speaker 4 executes the voice assistant function based on the wake word on the projector 1 and, when the state represented by the received state information is the second state, does not execute the voice assistant function based on the wake word on the projector 1.

According to the control method for the display system 1000 and the display system 1000, the voice assistant function based on the wake word is executed when the projector 1 is in the state in which the voice operation is allowed and the voice assistant function is not executed when the projector 1 is in the state in which the voice operation is not allowed. Accordingly, false operation of the voice assistant function by another voice than that of the user may be suppressed independent of the placement locations of the smart speaker 4 and the projector 1. Further, whether or not to execute the voice assistant function is changed according to the state of the projector 1 and it is not necessary to continuously analyze the voice data detected by the microphone 72, and thus, the processing load may be suppressed. Therefore, the control method for the display system 1000 and the display system 1000 may suppress the false operation of the voice assistant function based on the wake word by another voice than that of the user with the suppressed processing load.

The second state is a state in which the non-voice operation is allowed.

According to the configuration, the state of the projector 1 may be avoided from being a state not receiving any operation. Therefore, even when the state of the projector 1 is a state in which the voice operation is not allowed, the user may perform operation of the projector 1 e.g. start of image projection or the like by the non-voice operation.

If detecting the wake word when the projector 1 is in the second state, the smart speaker 4 stores the voice operation received within a predetermined time after the detection of the wake word and, when the projector 1 changes into the first state within the predetermined time, controls the projector 1 to execute processing corresponding to the stored voice operation as the voice assistant function.

According to the configuration, in a case when a voice indicating an operation is made when the state of the projector 1 is in the state in which the voice operation is not allowed, the user may control the projector to execute the voice assistant function based on the voice already made by changing the state of the projector 1 from the second state to the first state without making a voice of the wake word and a voice indicating the operation again.

The first state is a state in which the projector 1 does not output a voice. The second state is a state in which the projector 1 outputs a voice.

According to the configuration, false operation of the voice assistant function based on the wake word by the voice issued by the projector 1 may be prevented.

The above described respective embodiments are the preferred embodiments of the present disclosure. Note that the present disclosure is not limited to the above described embodiments, but various modifications can be made without departing from the scope of the present disclosure.

For example, in the above described second embodiment, the smart speaker 4 is exemplified as the voice assistant device, however, the voice assistant device may be any device that can detect a voice, not limited to the smart speaker 4. For example, a tablet terminal or a smartphone may be employed.

For example, in the above described first embodiment, the projector 1 performs voice recognition by analyzing the voice data of the voice detected by the microphone 72. However, the voice recognition may be performed by an external apparatus that can communicate with the projector 1. For example, when the projector 1 is coupled to a local network, the voice recognition may be performed by a host apparatus coupled to the local network, or, when the projector 1 is coupled to a global network such as the Internet, may be performed by a server, an AI, or the like coupled to the global network. In this case, the projector 1 transmits the voice data of the voice detected by the microphone 72 to the external apparatus and receives a result of the voice recognition from the external apparatus. In this case, the PJ memory unit 120 does not necessarily store the voice dictionary data 123.

The functions of the PJ control section 10 and the SP control section 400 may be realized by a plurality of processors or semiconductor chips.

For example, the respective functional parts of the projector 1 shown in FIGS. 3 and 4 and the respective functional parts of the smart speaker 4 shown in FIG. 4 show the functional configurations, but the specific embodiments are not particularly limited. That is, hardware individually corresponding to the respective functional parts is not necessarily mounted and, obviously, a configuration in which one processor executes programs to realize the functions of the plurality of functional parts can be employed. Alternatively, part of the functions realized by software in the above described embodiments may be realized by hardware or part of the functions realized by hardware may be realized by software. In addition, arbitrary changes can be made to the specific detailed configurations of the other respective parts of the projector 1 and the smart speaker 4 without departing from the scope of the present disclosure.

The units of processing in the flowcharts shown in FIGS. 2, 3, 7, and 8 are divided according to details of the main processing for easy understanding of the processing of the projector 1. The present disclosure is not limited by the division method and the names of the units of processing shown in the flowcharts. The processing of the projector 1 may be divided into more units of processing according to the details of the processing or divided so that one unit of processing may contain more processing. The orders of the processing in the above described flowcharts are not limited to those in the illustrated examples.

The units of processing in the flowcharts shown in FIGS. 5 and 6 are divided according to details of the main processing for easy understanding of the processing of the respective parts of the display system 1000. The present disclosure is not limited by the division method and the names of the units of processing shown in the flowcharts. The processing of the respective parts of the display system 1000 may be divided into more units of processing according to the details of the processing or divided so that one unit of processing may contain more processing. The orders of the processing in the above described flowcharts are not limited to those in the illustrated examples.

The display apparatus of the present disclosure is not limited to the projector 1 that projects the image on the screen SC. For example, the display apparatus includes a monitor or a self-emitting display apparatus such as a liquid crystal television e.g. a liquid crystal display apparatus that displays an image on a liquid crystal display panel and a display apparatus that displays an image on an organic EL panel. Further, the display apparatus of the present disclosure includes other various display apparatuses.

What is claimed is:

1. A control method for a display system having a voice assistant device and a display apparatus comprising:
transmitting, by the display apparatus, state information representing that the display apparatus is in one state of a first state in which a first operation by a voice is allowed and a second state in which the first operation by the voice is not allowed to the voice assistant device; and
when the state information is the first state, executing a voice assistant function based on a wake word on the display apparatus and,
when the state information is the second state, not executing, by the voice assistant device, the voice assistant function based on the wake word on the display apparatus.

2. The control method for the display system according to claim 1, wherein
the second state is a state in which a second operation by other than the voice is allowed.

3. The control method for the display system according to claim 1, wherein
if the wake word is detected when the display apparatus is in the second state, the voice assistant device stores the first operation received within a predetermined time after the detection of the wake word and,
when the display apparatus changes into the first state within the predetermined time, the voice assistant device controls the display apparatus to execute processing corresponding to the stored first operation in the voice assistant device as the voice assistant function based on the wake word.

4. The control method for the display system according to claim 1, wherein
the first state is a state in which a volume of the display apparatus is set to zero, and
the second state is a state in which a volume of the display apparatus is set to zero.

5. A display system comprising:
a voice assistant device; and
a display apparatus configured to communicate with the voice assistant device, wherein
the display apparatus is in one state of a first state in which a first operation by a voice is allowed and
the display apparatus is in one state of a second state in which the first operation is not allowed, and
the voice assistant device transmits state information representing that the display apparatus is in one state of the first state in which the first operation by the voice is allowed and the second state in which the first operation is not allowed to the voice assistant device, and
when the state represented by the received state information is the first state, the voice assistant device executes a voice assistant function based on a wake word on the display apparatus and, when the state represented by the received state information is the second state, does not execute the voice assistant function based on the wake word on the display apparatus.

6. A control method for a display apparatus having a voice detection unit, configured to execute a voice assistant function based on a wake word, and being in one state of a first state and a second state, comprising;
when a state of the display apparatus is the first state in which an operation by a voice detected by the voice detection unit is allowed and the voice detected by the voice detection unit contains the wake word, responding to the wake word and,
when the state of the display apparatus is the second state in which the operation by the voice detected by the voice detection unit is not allowed, not responding to the wake word.
